(19) United States
(12) Patent Application Publication
(10) Pub. No.: US 2020/0065631 A1
(43) Pub. Date: Feb. 27, 2020

(54) Produce Assessment System

(71) Applicant: Jonathan Meyers, Missoula, MT (US)

(72) Inventor: Jonathan Meyers, Missoula, MT (US)

(21) Appl. No.: 16/547,546

(22) Filed: Aug. 21, 2019

Related U.S. Application Data
(60) Provisional application No. 62/720,379, filed on Aug. 21, 2018.

(51) Int. Cl. G06K 9/62; G06N 20/00; G06T 7/00

(52) U.S. Cl. CPC G06K 9/6263; G06N 20/00; G06T 7/0004; G06K 2209/17; G06T 2207/30128; G06T 2207/20081; G06K 9/6253

(57) ABSTRACT

The system described here utilizes at least one electronic processor, an image analysis application executing on at least one electronic processor, image data, and a machine learning application executing on at least one electronic processor to analyze images containing representations of at least one piece of produce. The analysis provides an assessment of the quality of the piece of produce and that assessment is displayed on an output device. The user can provide feedback as to the accuracy of the assessment and that feedback is used to improve future assessments by the machine learning application. The assessment can be used to by a user of the system to decide whether to purchase or use a particular piece of produce shown in the image.

### CROSS-REFERENCE TO RELATED APPLICATION

This application claims the benefit under 35 U.S.C. § 119(e)(1) of U.S. Provisional Application No. 62/720,379, filed Aug. 21, 2018, which is hereby incorporated by reference in its entirety.

### BACKGROUND

Modern produce growers, distributors, and sellers use high tech systems to evaluate, assess, grade, and approve produce for sale on a daily basis. Unfortunately, consumers do not have access to such technology at the point of sale and thus have only the highly inaccurate and inconsistent process of seeing, feeling, and smelling produce to assess the suitability for purchase. However, the assessment system described herein leverages data science (data analytics) and machine learning techniques, based on neural networks, Bayesian networks, deductive logic, probabilistic models, pattern recognition, and the like, to determine the suitability of produce for purchase by individual consumers at the point of selection. Using a smart phone or other mobile computing device that includes a camera, the system described here captures at least one photograph of at least one piece of produce, analyzes the details of the photograph using data analytics and machine learning, calculates a quantitative assessment of the produce, and provides the assessment to a user allowing the user to decide whether to buy the produce. The Produce Assessment System integrates hardware and software into a system that provides users with produce assessment not currently available to users and significantly different than commercial systems which include expensive and sophisticated hardware and a controlled environment for assessment. The Produce Assessment System described herein utilizes portable computing devices, one or more assessment servers, or both to provide timely produce assessment to users.

### FIELD OF THE INVENTION

Embodiments described herein relate to an assessment system usable by individuals to assess the suitability of produce for purchase.

### SUMMARY

The Produce Assessment System described herein is a mobile, data-driven, intelligent produce assessment system that takes advantage of mobile computing devices and cameras embedded or attached to such devices to gather visual data which can then be analyzed using data analytics and machine learning to provide real-time feedback to a user. At present, nearly all mobile computing devices, specifically including smartphones and tablets, include high resolution cameras that can capture very detailed images. Such images may include millions of pixels, each with a color code that captures colors in more detail than the human eye. This data forms the basis of analysis wherein data analytics can be used to filter, refine, enlarge, or otherwise alter the original image in ways that allow machine learning algorithms to intelligently analyze produce in the image against hundreds or even thousands of other images of produce. Such detailed analysis and comparison to other produce allows individual pieces of produce to be assessed for suitability of purchase at the point of selection. The Produce Assessment System includes feedback from not only the user of the system but integrates feedback from all users to improve the accuracy of the system and, more importantly, improve the accuracy of the system for a number of points in time. For example, an avocado may display ripeness with a more uniform darker skin earlier in the harvest season and more spotted skin including both dark and light color later in the harvest season. The system described herein provides increasingly accurate produce assessment to the user by taking advantage of user feedback and data analytics based on this feedback.

The Produce Assessment System provides users with the ability to quickly determine the suitability of produce for purchase and to improve the system by providing feedback when the produce is used or consumed. The system can, in some embodiments, adjust the influence of user feedback based on the length of time between purchase and use so as to improve accuracy by considering the age of the produce as measured from purchase to use. In addition, the system can prompt users to adjust image collection in real time using data analytics of the image, thus removing the influence of light, shadows, or size of the produce in the image. With user feedback at image capture the system can perform more accurate analysis and assessment using machine learning techniques. The user may, in some embodiments, receive assessment results in a few seconds that can be used to guide their purchase decisions.

The Produce Assessment System provides real-time analysis and assessment of produce not previously available by allowing providing a system that performs data analytics and machine learning on images of produce. The Produce Assessment System includes an electronic processor, a camera, a data storage device, an input device, an output display, and a communication device to communicate with a server, if needed. In some embodiments, the Produce Assessment System can analyze an image and assess the produce in an image on the user device while in other embodiments the image is analyzed and the produce assessed on a server connected to the personal computing device held by the user. The image is subject to data analytics to evaluate content and, in some cases, filtered or altered to enhance the ability of the machine learning system to assess the produce in the image. The machine learning system utilizes data, including but not limited to, previous images of produce, date and time data, feedback from the user and other users, and accuracy calculations captured recently, over a period of time, or both. The machine learning system may use neural networks, Bayesian networks, deductive logic, probabilistic models, pattern recognition, and the like. The Produce Assessment System then provides an assessment to the user on the user output display and accepts user feedback then, or in the future, as to the accuracy of the assessment. Such feedback may be used, in some embodiments, to improve the system over time.

### BRIEF DESCRIPTION OF THE DRAWINGS

FIG. 1 illustrates an example embodiment of the Produce Assessment System which includes a server for image analysis using data analytics, assessment using machine learning, or both.

FIG. 2 illustrates an example embodiment of the Produce Assessment System when resident entirely on a portable computing device.

FIG. 3 illustrates a method for determining a quality assessment of produce using the system the system of FIG. 1.

FIG. 4 illustrates a method for determining a quality assessment of produce using the system of FIG. 2.

FIG. 5 illustrates a method of image analysis that may be used to analyze images as referenced in block 220 of FIG. 3.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that configuration but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

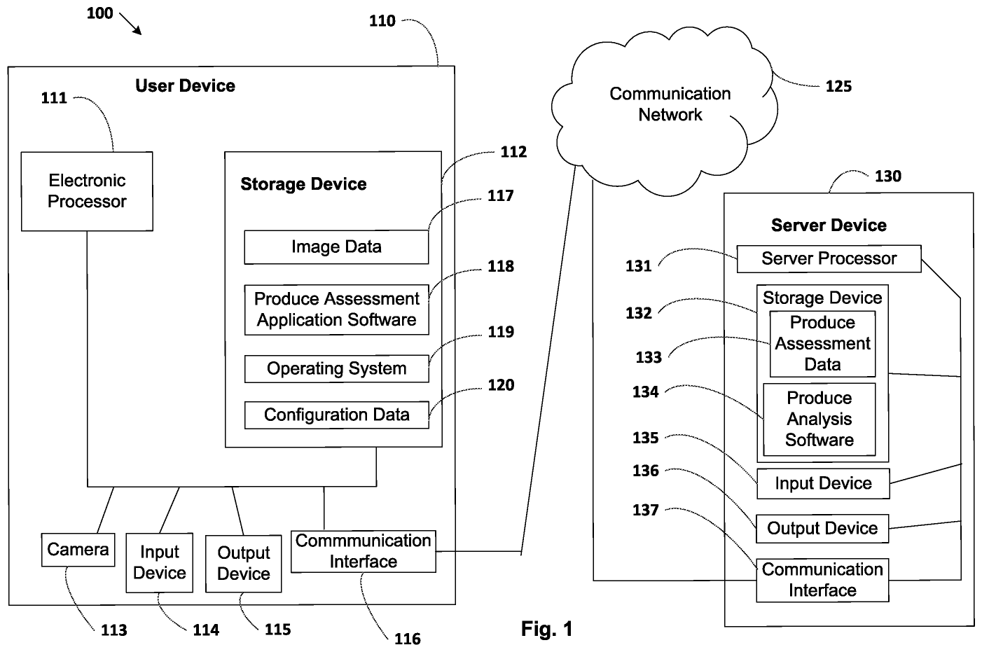

FIG. 1 illustrates an example embodiment of the Produce Assessment System 100 for assessing produce captured in an image. In the example illustrated in FIG. 1, the system 100 includes a user device 110, a communication network 125, and a server device 130. The user device 110 may be a laptop, a tablet computer, a smart telephone, a smart watch, or another type of computing device.

The user device 110 includes an electronic processor 111 and a storage device 112. The storage device 112 stores computer instructions, data, images, and other information as needed to operate the user device 110. The user device also includes a camera 113, an input device 114, and output device 115, and a communication interface 116. The electronic processor 111, the storage device 112, the camera 113, the input device 114, the output device 115, and the communication interface 116 communicate over one or more communication lines or buses, wireless connections, or a combination thereof. It should be understood that, in various configurations, the user device 110 may include additional or alternative components than those illustrated in FIG. 1 and may perform additional functions than the functions described herein. For example, in some embodiments, the user device 110 may include multiple processors, storage devices, input devices, output devices, web browsers, communication interfaces, or a combination thereof.

The electronic processor 111 may include one or more microprocessors, application-specific integrated circuits (ASICs), or other suitable electronic devices. The storage device 112 includes a non-transitory, computer readable medium. For example, the storage device 112 may include a hard disk, an optical storage media, a magnetic storage device, ROM (read only memory), RAM (random access memory), register memory, a processor cache, or a combination thereof. The communication interface 116 sends data to devices or networks external to the user device 110, receives data from devices or networks external to the user device 110 which may include external data bases, servers, cloud services, or cloud storage, or a combination thereof.

The camera 113 may be integrated into the user device 110, such as camera built into the user device 110 when such device is a smart phone, or, may be attached to the user device 110 through a wired or wireless connection (not shown in FIG. 1). In FIG. 1 the camera 113 is connected to a bus or other communication line linking the camera 113 with other components of the user device 110. In this example embodiment of the Produce Assessment System, the camera 113 captures one or more images and stores them in the storage device 112 along with image identifiers such as user identification, date stamp, time stamp, location, or the like.

The input device 114 receives input from a user. For example, the input device 114 may be or include a keyboard, keypad, a mouse or trackball, a touchscreen, a microphone, fingerprint reader, or other input devices. The output device 115 provides output to a user. For example, the output device 115 may be or include a display, light emitting diodes (LEDs), a speaker, or other output devices. A touch screen, which combines display, input, and cursor-control functions may also be used. The storage device 112 stores instructions executable by the electronic processor 111 to perform the functionality described herein, including executing the camera 113.

The communication interface 116 may include a transceiver for wirelessly communicating over one or more communication networks, such as a wide area network, such as the Internet, a local area network, such as Bluetooth™ network or Wi-Fi, and combinations or derivatives thereof. Alternatively, or in addition, in some embodiments, the communication interface 116 includes a port for receiving a wire or cable, such as an Ethernet cable or a universal serial bus (USB) cable, to facilitate a connection to an external device or network.

The storage device 112 stores image data 117, produce assessment application software 118, operating system 119, and configuration data 120 in the example embodiment shown in FIG. 1. The image data 117 may contain images of produce selected for assessment or those previously assessed, or images to be used to filter, enlarge, reduce, or compare to images selected for assessment or previously assessed. The image data 117 may contain data about images, such as their size, resolution, time and data captured, location, and tags as to assessment results. Some or all of the image data 117 may be used by the produce assessment application software 118 to perform analysis of raw image data or assessment functions. The produce assessment application software, executing on electronic processor 111 may communicate through the communication interface 116, across one or more communication networks 125 with the server device 130.

The operating system 119 executing on the electronic processor 111 coordinates and controls operation of the user device 110 which includes controlling and coordinating the produce assessment application software 118, and other software applications and hardware control software, stored in the storage device 112. The operating system 119 uses configuration data 120 to determine how to control and coordinate software applications and hardware control software as well as execute the produce assessment application software 118.

The server device 130 includes at least one server processor 131 and storage device 132. The storage device 132 stores produce assessment data 133 which includes images and data which are used by the produce analysis software 134. The produce analysis software 134 executes on server processor 131 wherein the produce analysis software 134 causes the server processor to analyze the image data and assess produce in the image using machine learning techniques that compare the image to known images of produce and derive an assessment as to the state of the produce. The server device 130 also includes an input device 135, an output device 136, and a communication interface 137 in this example embodiment. It should be understood the input device 135, and the output device 136 may be remotely located and connected to or communicate with the server device 130 in other embodiments without affecting system execution or functionality of the invention described here. It should also be understood that the produce assessment application software 118 may be part of the server device 130 or may be hosted on an external device, for example, a virtual or remotely located server (not shown) and access the user device 110 and service device 130 through the communication network 125. Alternatively, the image data 117 and the produce assessment data 133 may be located on a remote file server or database, or some combination of these may be located on different servers or databases without affecting system execution or functionality as described here.

The example embodiment shown in FIG. 1 allows the user device 110 to receive input from a user, the input comprised of a request for assessment of an image captured by camera 113. The produce assessment application software 118 executing on electronic processor 111 analyzes the image stored in the image data 117 and generates a request to the server device 130 to assess the image. The user device 110 sends a copy of the image to be assessed to the server device 130 where said copy is stored with or in addition to the produce assessment data 133. The request causes the server device to execute the produce analysis software 134 on server processor 131, wherein the produce analysis software 134 uses machine learning to assess the image in comparison to a plurality of images and image data stored in the produce assessment data 133. The produce analysis software 134 derives an assessment of the produce in the image, if any, and communicates the assessment using communication interface 137, over communication network 125, to user device 110 for display to a user on output device 115. The user device 110 displays an assessment of the image on output device 115 and the user may provide feedback to the produce assessment application software 118, which may be communicated to the produce assessment data 133 for use in assessing future images or providing feedback on assessment results.

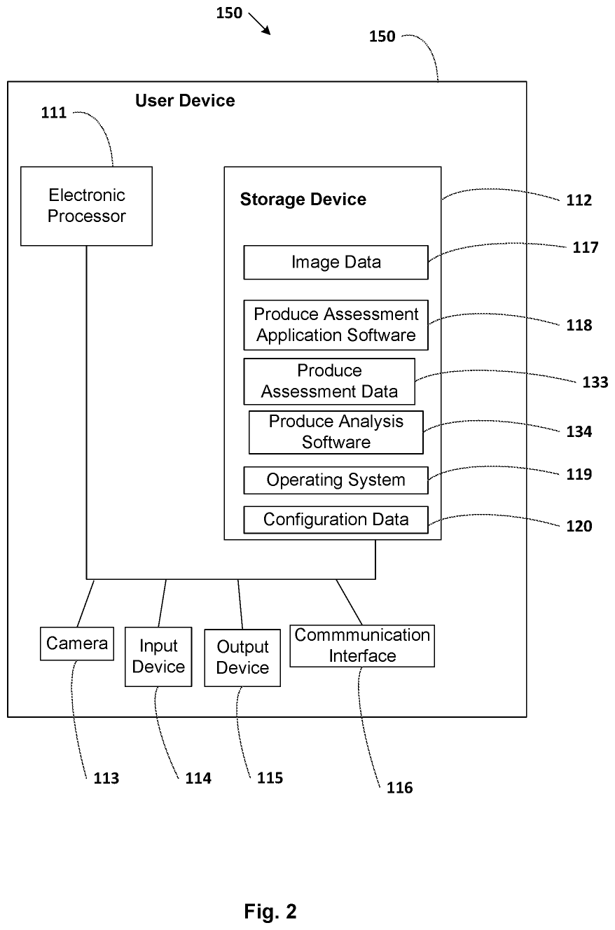

FIG. 2 illustrates another example embodiment of the Produce Assessment System contained on User Device 150 wherein the Produce Analysis Software 134 and Produce assessment Data 133 are placed in Storage Device 112 allowing the Produce Assessment System to determine an assessment of produce without the need to communicate with a second electronic processor on a server device, and to operate where no communication network exists. One skilled in the art will recognize the example embodiment shown in FIG. 2 can perform the functions described herein in the same way shown and described in FIG. 1. Further, the increase in processing speed and data storage capacities of handheld, wearable, and tablet devices, for example, continue to rise and therefore allow for analytic and machine learning processes to be performed efficiently on such user devices.

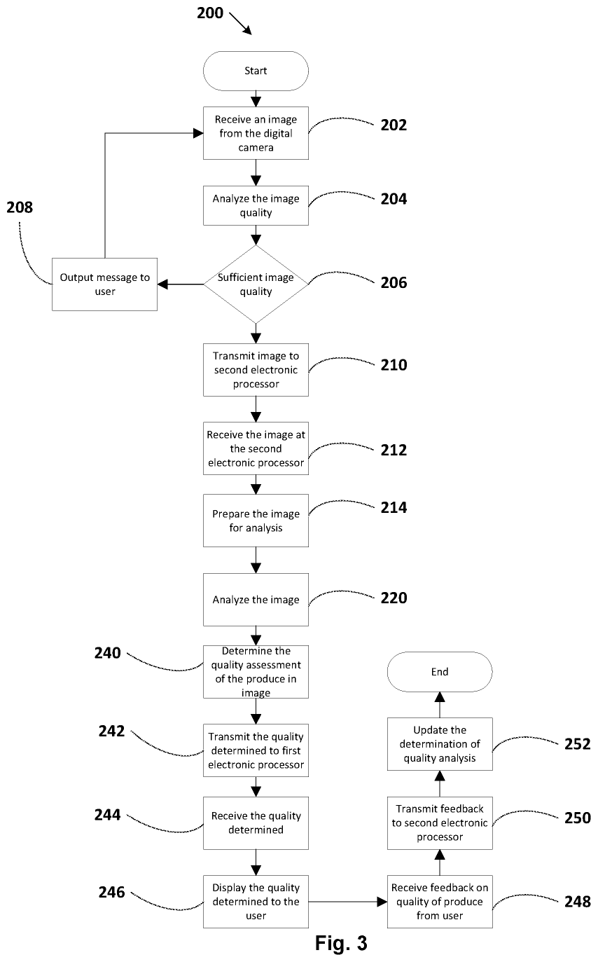

FIG. 3 illustrated a method 200 of assessing the quality of product using the system described in FIG. 1, according to one embodiment. As illustrated in FIG. 3, as part of method 200, the Produce Assessment Application Software 118 receives an image from Camera 113 (at block 202). Produce Assessment Application Software 118 analyses image quality (at block 204) and then determines if sufficient image quality exists (at decision block 206). Such determination may include converting a color image to a gray-scale image, measuring contrast, brightness, and determining other characteristics of the image as to the suitability of the image for produce assessment. If the image is not suitable for produce assessment then a message is output to the user (at block 208) and another image may be received, otherwise the image is transmitted from User Device 110, using Communication Interface 116, to the Server Device 130 (at block 210). Server Device 130 receives the image through Communication Interface 137 (at block 212) where the image may be stored in Produce Assessment Data 133, or stored in transitory memory for analysis.

As shown in FIG. 3, Server Processor 131 executing Produce Analysis Software 134 prepares the image for analysis (at block 214). The preparation in some embodiments may include modifying the image by normalizing the size of the produce in the image to allow more accurate comparison with Produce Assessment Data 133. For example, the produce in the image may occupy a large portion of the image as measured by the height and width of the produce image in relation to the height and width of the total image, or a comparison of pixels representing the produce to the total pixels in the image. The Produce Analysis Software 134 may reduce the size of the produce image to fit within a range of produce image sizes while maintaining the ratio of height to width (at block 214). The Produce Analysis Software 134 may also, in some embodiments, change pixel values to increase the contrast between portions of the image or increase the contrast of edges which delineate the produce, other items, or both in the image (at block 214). In some embodiments, the Produce Analysis Software 134 includes a function to partition at least one produce represented in the image from the background and other non-produce items (at block 214) so that the produce in the image may be more effectively analyzed. In some embodiments, the Produce Analysis Software 134 also extracts features from the image using data such as a user identification, date stamp, time stamp, and location (at block 214).

With the image prepared for analysis, the Produce Analysis Software 134 uses one or more machine learning algorithms to analyze the produce in the partition of the image to obtain an assessment of the quality of the produce (at block 220). The machine learning algorithm in some embodiments may be a classifier which calculates similarities between images of produce in known quality states, or in other embodiments may use a neural network to calculate similarity between produce image partitions and images of produce in known quality states through summation or integration of quantities calculated by each node in the neural network (at block 220). The results of the analysis, in some embodiments, are used to contribute to determining the assessment of quality of the produce represented in the image (at block 240). The determination of the assessment of quality combines the machine learning analysis with data such as a user identification, date stamp, time stamp, and location to obtain the assessment (at block 242).

The Produce Analysis Software 134 transmits the quality assessment through the Communication Interface 137 to the User Device 110 (at block 220). The Produce Assessment Application Software 118 on the User Device 110 receives the quality assessment through Communication Interface 120 (at block 244) and displays the quality assessment on Output Device 115 (at block 246). The user of the User Device 110 reviews the assessment of quality and the User Device receives feedback from the user through Input Device 114 on the quality of the produce (at block 248) and transmits the user feedback through Communication Interface 116 to Server Device 130 (at block 250). The Produce Analysis Software 134 updates the machine learning algorithm, determination of quality assessment, or both, to be more accurate in the future (at block 252).

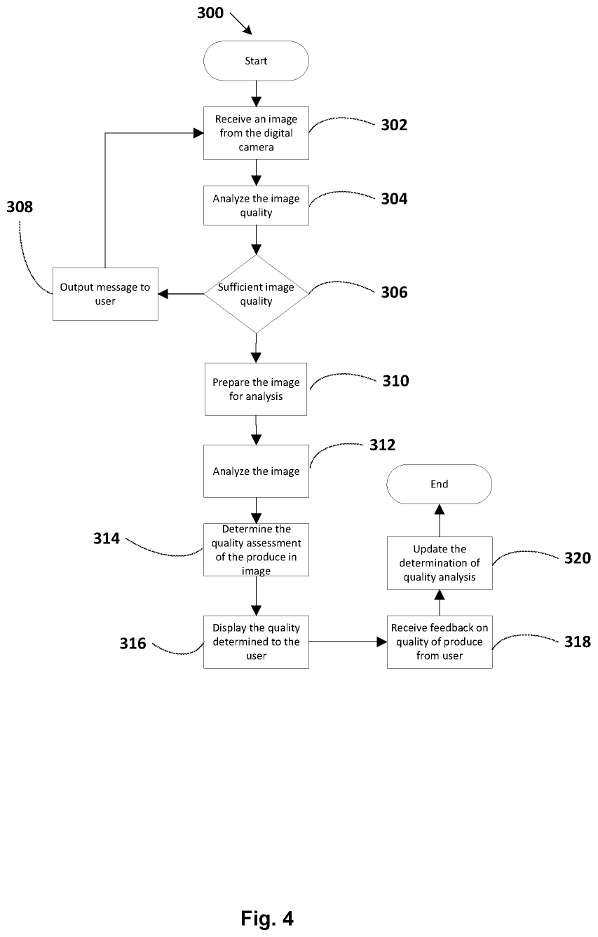

FIG. 4 illustrated a method 300 of assessing the quality of product using the system described in FIG. 2, according to one embodiment. FIG. 2 illustrates a system which determines a produce quality assessment on User Device 150 without the need for processing on a second electronic processor located externally to the User Device 150. As illustrated in FIG. 4, as part of method 300, the Produce Assessment Application Software 118 receives an image from Camera 113 (at block 302). Produce Assessment Application Software 118 analyses image quality (at block 304) and then determines if sufficient image quality exists (at decision block 306). Such determination may include converting a color image to a gray-scale image, measuring contrast, brightness, and determining other characteristics of the image as to the suitability of the image for produce assessment. If the image is not suitable for produce assessment then a message is output to the user (at block 308) and another image may be received, otherwise the image can be further processed.

As shown in FIG. 4, Produce Analysis Software 134 prepares the image for analysis (at block 310). The preparation in some embodiments may include modifying the image by normalizing the size of the produce in the image to allow more accurate comparison with Produce Assessment Data 133. For example, the produce in the image may occupy a large portion of the image as measured by the height and width of the produce image in relation to the height and width of the total image, or a comparison of pixels representing the produce to the total pixels in the image. The Produce Analysis Software 134 may reduce the size of the produce image to fit within a range of produce image sizes while maintaining the ratio of height to width (at block 310). The Produce Analysis Software 134 may also, in some embodiments, change pixel values to increase the contrast between portions of the image or increase the contrast of edges which delineate the produce, other items, or both in the image (at block 310). In some embodiments, the Produce Analysis Software 134 includes a function to partition the at least one produce represented in the image from the background and other non-produce items (at block 310) so that the produce in the image may be more effectively analyzed. In some embodiments, the Produce Analysis Software 134 also extracts features from the image using data such as a user identification, date stamp, time stamp, and location (at block 310).

With the image prepared for analysis, the Produce Analysis Software 134 uses one or more machine learning algorithms to analyze the produce in the partition of the image to obtain an assessment of the quality of the produce (at block 312). The machine learning algorithm in some embodiments may be a classifier which calculates similarities between images of produce in known quality states, or in other embodiments may use a neural network to calculate similarity between produce image partitions and images of produce in known quality states through summation or integration of quantities calculated by each node in the neural network (at block 312). The results of the analysis, in some embodiments, are used to contribute to determining the assessment of quality of the produce represented in the image (at block 314). The determination of the assessment of quality combines the machine learning analysis with data such as a user identification, date stamp, time stamp, and location to obtain the assessment (at block 314).

The Produce Analysis Software 134 displays the quality assessment on Output Device 115 (at block 316). The user of the User Device 110 reviews the assessment of quality and the User Device receives feedback from the user through Input Device 114 on the quality of the produce (at block 318). The Produce Analysis Software 134 updates the machine learning algorithm, determination of quality assessment, or both to be more accurate in the future (at block 320).

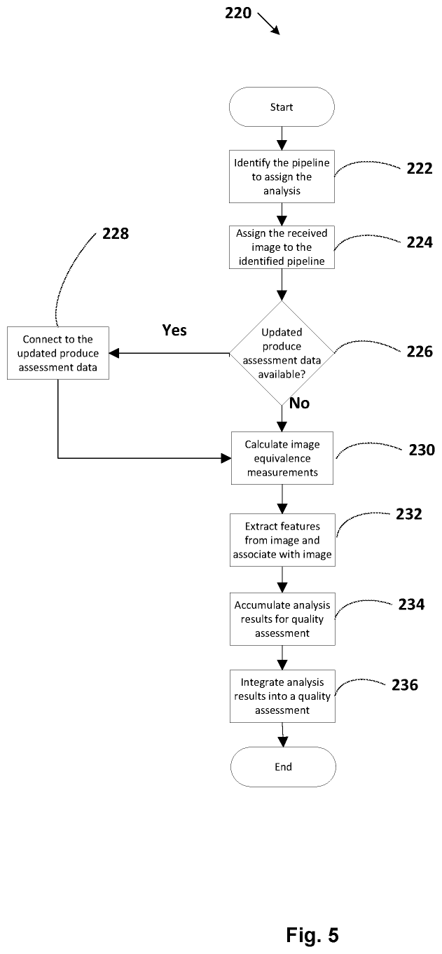

As shown in FIG. 5, once an image has been prepared for analysis (at block 214 of FIG. 3), the Produce Analysis Software 134 analyzes the image (at block 220 of FIG. 3). Analysis of the image begins by identifying at least one computational pipeline from a group of available computational pipelines that can execute Produce Analysis Software 134 on an electronic processor to assign the analysis (at block 222), and then assigns the received image to the identified computational pipeline (at block 224). Produce Analysis Software 134 executing on electronic processor through the assigned pipeline determines if Produce Assessment Data 133 has been updated through feedback from a user (at decision black 226). If updated image data is available, then Produce Analysis Software 134 connects to the updated Produce Assessment Data 133 (at block 228). Produce Analysis Software 134 calculates image equivalence measurements (at block 230) using image data stored in Produce Assessment Data 133 to compare with received image. Selected features are extracted from the received image and compared to data in Produce Assessment Data 133 which may include, for example, images of produce in known quality states (at block 232). The results of calculated equivalence measurements and feature extraction are accumulated into an overall quality assessment (at block 234) and integrating analysis results into a quality assessment of produce in the received image, which may involve machine learning, user feedback, analyzing additional images captured and provided to the Produce Analysis Software 134, or a combination of these actions (at block 236).

One skilled in the art will recognize the example embodiments of the Produce Assessment System 100 shown in FIG. 1 and FIG. 2 implement similar methods where one system uses an external computing device to perform image preparation and analysis, and determines the quality assessment of the representation of the produce in the image. The external computing device in FIG. 1 could be a stand-alone desktop computer, server, cloud instance of multiple servers, or some combination thereof. Similarly, the system of FIG. 2 could be embodied on a hand-held device, tablet, laptop, desktop, or computing device with external storage. One skilled in the art could embody the Produce Assessment System in multiple ways to implement the example methods described in FIG. 3 and FIG. 4.

Various features and advantages of some embodiments are set forth in the following claims.

What is claimed is:

1. A system for assessing produce comprising:
a digital camera configured to capture an image of at least one piece of produce; and
a first electronic processor configured to:
receive the image of at least one piece of produce from the camera,
tag the image of at least one piece of produce with at least one identifier,
analyze the image of at least one piece of produce to verify that the image can be assessed,
analyze the image of at least one piece of produce using data of a repository of produce assessment data,
determine an assessment of the quality of the at least one piece of produce in the image,
display on an output device the assessment of the quality of the at least one piece of produce,
receive, through an input device, feedback from a user as to the accuracy of the assessment of quality of the at least one piece of produce, and
modify, at least in part based on the feedback from the user, at least some of the data of the repository of produce assessment data.

2. The system of claim 1, wherein the first electronic processor is further configured to store images of produce and assessment data in the repository of produce assessment data.

3. The system of claim 1, wherein analyzing the image of at least one piece of produce using data of the repository of produce assessment data comprises applying a machine learning algorithm.

4. The system of claim 3, wherein determining an assessment of the quality of the at least one piece of produce in the image comprises determining the assessment based at least in part on the results of the machine learning applied to the image to the produce assessment data.

5. The system of claim 3, wherein the machine learning comprises at least one technique selected from: a neural network, a Bayesian network, a deductive logic system, at least one probabilistic model, and a pattern recognition algorithm.

6. The system of claim 3, wherein the first electronic processor is further configured to:
store, in the repository of produce assessment data, the feedback from the user as to the accuracy of the assessment of quality of the at least one piece of produce,
alter the produce assessment data based on the feedback from the user, and
alter the machine learning algorithm based on the feedback from the user.

7. The system of claim 1, wherein the at least one identifier comprises one or more piece of information selected from: a user identification, date stamp, time stamp, and location.

8. The system of claim 1, wherein the first electronic processor is further configured to:
determine that the image cannot be properly analyzed,
prompt a user to capture a replacement image of at least one piece of produce, and
substitute the replacement image for the image of at least one piece of produce.

9. A system for assessing produce comprising:
a digital camera configured to capture an image of at least one piece of produce; and
an electronic processor configured to:
receive the image of at least one piece of produce from the camera,
tag the image of at least one piece of produce with at least one identifier,
analyze the image of at least one piece of produce to verify that the image can be assessed,
analyze the image of at least one piece of produce, the analyzing comprising applying a machine learning algorithm to at least some data of a repository of produce assessment data,
determine an assessment of the quality of the at least one piece of produce in the image,
display on an output device the assessment of the quality of the at least one piece of produce,
receive, through an input device, feedback from a user as to the accuracy of the assessment of quality of the at least one piece of produce, and
update the machine learning algorithm and repository of produce assessment data based on the feedback from the user.

10. The system of claim 9, wherein determining an assessment of the quality of the at least one piece of produce in the image comprises determining the assessment based at least in part on the results of the machine learning applied to the image to the produce assessment data.

11. The system of claim 9, wherein the machine learning comprises at least one technique selected from: a neural network, a Bayesian network, a deductive logic system, at least one probabilistic model, and a pattern recognition algorithm.

12. The system of claim 9, wherein the electronic processor is further configured to:
store, in the repository of produce assessment data, the feedback from the user as to the accuracy of the assessment of quality of the at least one piece of produce,
alter the produce assessment data based on the feedback from the user, and
alter the machine learning based on the feedback from the user.

13. The system of claim 9, wherein the at least one identifier comprises one or more piece of information selected from: a user identification, date stamp, time stamp, and location.

14. The system of claim 9, wherein the electronic processor is further configured to:
determine that the image cannot be properly analyzed,
prompt a user to capture a replacement image of at least one piece of produce, and
substitute the replacement image for the image of at least one piece of produce.

15. A method of assessing produce, the method comprising:
receiving, from a digital camera, an image of at least one piece of produce;
tagging the image of at least one piece of produce with at least one identifier;
analyzing the image of at least one piece of produce to verify that the image can be assessed;
analyzing the image of at least one piece of produce using data of a repository of produce assessment data;
determining an assessment of the quality of the at least one piece of produce in the image;
displaying, on an out put device, the assessment of the quality of the at least one piece of produce;
receiving, through an input device, feedback from a user as to the accuracy of the assessment of quality of the at least one piece of produce; and
modifying, at least in part based on the feedback from the user, at least some of the data of the repository of produce assessment data.

16. The method of claim 15, wherein analyzing the image of at least one piece of produce using data of the repository of produce assessment data comprises applying a machine learning algorithm.

17. The method of claim 16, wherein determining an assessment of the quality of the at least one piece of produce in the image comprises determining the assessment based at least in part on the results of the machine learning applied to the image to the produce assessment data.

18. The method of claim 16, wherein the machine learning comprises at least one technique selected from: a neural network, a Bayesian network, a deductive logic system, at least one probabilistic model, and a pattern recognition algorithm.

19. The method of claim 16, further comprising:
storing, in the repository of produce assessment data, the feedback from the user as to the accuracy of the assessment of quality of the at least one piece of produce,
altering the produce assessment data based on the feedback from the user, and
altering the machine learning algorithm based on the feedback from the user.

20. The method of claim 15, wherein the at least one identifier comprises one or more piece of information selected from: a user identification, date stamp, time stamp, and location.
